(19) United States
(12) Patent Application Publication
(10) Pub. No.: US 2017/0104242 A1
(43) Pub. Date: Apr. 13, 2017

(54) BATTERY SYSTEM

(71) Applicant: Electrijet Flight Systems Inc, Liberty Lake, WA (US)

(72) Inventors: Brett Michael Clark, Spokane Valley, WA (US); James William Edwards, Spokane Valley, WA (US); Devin Glenn Samuelson, Greenacres, WA (US)

(21) Appl. No.: 15/288,915

(22) Filed: Oct. 7, 2016

Related U.S. Application Data
(60) Provisional application No. 62/238,698, filed on Oct. 8, 2015.

(51) Int. Cl. H01M 10/39; H01M 2/08; H01M 10/04; H01M 4/38

(52) U.S. Cl. CPC H01M 10/3963; H01M 4/381; H01M 2/08; H01M 10/04

(57) ABSTRACT

Battery systems, and methods for manufacturing the same, are disclosed. The battery system may include one or more layers of anode, cathode, and electrolyte. The electrolyte may be solid, dense, and thin. The electrolyte may be configured in a non-planar geometry, such as a concentric cylindrical geometry or a helical geometry. A sealant may be applied to a housing enclosing the anode, cathode, and a portion of the electrolyte such that electrode-to-electrode contact is prevented. The method of manufacturing a battery system may include sonicating materials forming the electrolyte and curing the materials in layers. The anode and cathode materials are applied to the electrolyte and are enclosed in the housing. The sealant is applied such that contact is prohibited between the anode and the cathode.

### RELATED APPLICATION

The present non-provisional application claims priority to provisional U.S. Patent Application No. 62/238,698, entitled “Electrochemical Storage Battery with an Ultra-Thin Membrane,” which was filed on Oct. 8, 2015, which is hereby incorporated by reference in its entirety.

### BACKGROUND

Batteries provide the ability to store energy and deliver electricity in numerous applications. The use of batteries in applications such as aerospace and automotive highlights several limitations of current battery technologies. These limitations include limited energy density for applications requiring large amounts of energy, reduced battery performance from charge/discharge cycling, large battery mass, high operating temperature, and electrolyte failure, to name a few. Of these limitations, electrolyte cracking such that electrode-to-electrode contact occurs represents one of the most common failure types. To solve this problem, thick electrolytes with low density have been used to make the electrolyte more durable. However, low density, thick electrolytes increase internal resistance and operating temperature, which decrease battery performance. Additionally, typical batteries employ a simple planar geometry, which limits performance and customization for given applications.

As such, the batteries described above suffer from several drawbacks. For example, relatively thick electrolytes result in a higher operating temperature and limit the diversity of applications in which a battery may be used.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The apparatuses depicted in the accompanying figures are not to scale and components within the figures may be depicted not to scale with each other.

FIG. 1 illustrates a side, cross-sectional view of an example battery system.

FIG. 2 illustrates a perspective view of an example battery system.

FIG. 3 illustrates a top, cross-sectional view of an example battery system.

FIG. 4 illustrates a side, cross-sectional view of an example battery system.

FIG. 5 illustrates a side, cross-sectional view of another example battery system.

FIG. 6 illustrates a top, cross-sectional view of another example battery system.

FIG. 7 illustrates a flow diagram of a method of manufacturing an example battery system.

### DETAILED DESCRIPTION

Overview

This disclosure describes example battery systems and methods of manufacturing the same.

The battery systems described herein provide high energy density, decreased battery mass, decreased operating temperature, and decreased electrolyte failure by, for example, using a solid, dense, thin electrolyte. The battery systems may be manufactured using selective laser sintering or stereolithography, which may allow for various unique battery configurations such as concentric cylindrical and helical geometries. Other configurations may also be used, such as, for example, concentric ovals, triangles, squares, and other polygonal shapes. Thus, some of the advantages of using the presently disclosed battery systems include but are not limited to longer battery life, increased energy storage, and customizable configuration for given applications.

In an example, the system may include one or more anodes and one or more cathodes. The anodes and cathodes may be in a liquid state or a partially liquid state. An electrolyte, which may be solid, may be disposed between the anode and the cathode. The electrolyte may be relatively dense, such as, for example, at least 95% theoretical density. Additionally, the electrolyte may have a thickness that is less than or equal to 1/10 of the thickness of the anode or the cathode. A housing may enclose the anode, the cathode, and at least a portion of the electrolyte. In examples, two or more layers of anode, electrolyte, and cathode may be present.

In another embodiment, the system may include a solid electrolyte configured in two or more layers with each of the two or more layers having a concentric cylindrical geometry. For at least one of the two or more layers, a first material functioning as an anode may be disposed on a first side of the electrolyte and a second material functioning as a cathode may be disposed on a second side of the electrolyte.

In yet another embodiment, a method of manufacturing a battery system may include sonicating by, for example, ultrasonic vibrations, a composition that may include one or more of alpha-alumina powder, sodium oxide powder, and lithium oxide powder. The method may further include curing the composition in layers to produce a solid electrolyte, which may have a thickness of, for example, less than 10 micrometers. The curing may be performed by selective laser sintering or stereolithography, for example. The method may also include applying a first material functioning as an anode to a first side of the electrolyte and applying a second material functioning as a cathode to a second side of the electrolyte. The method may further include enclosing the anode, the cathode, and a first portion of the electrolyte within a housing, which may have grooves sized such that a second portion of the electrolyte may extend through the grooves to an exterior of the housing. Furthermore, the method may include applying a sealant to the exterior of the housing such that the second portion of the electrolyte is at least partially covered by the sealant. The sealant may function as a barrier or partial barrier between the cathode and anode.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

Additional details are described below with reference to several example embodiments.

### Example Battery Systems

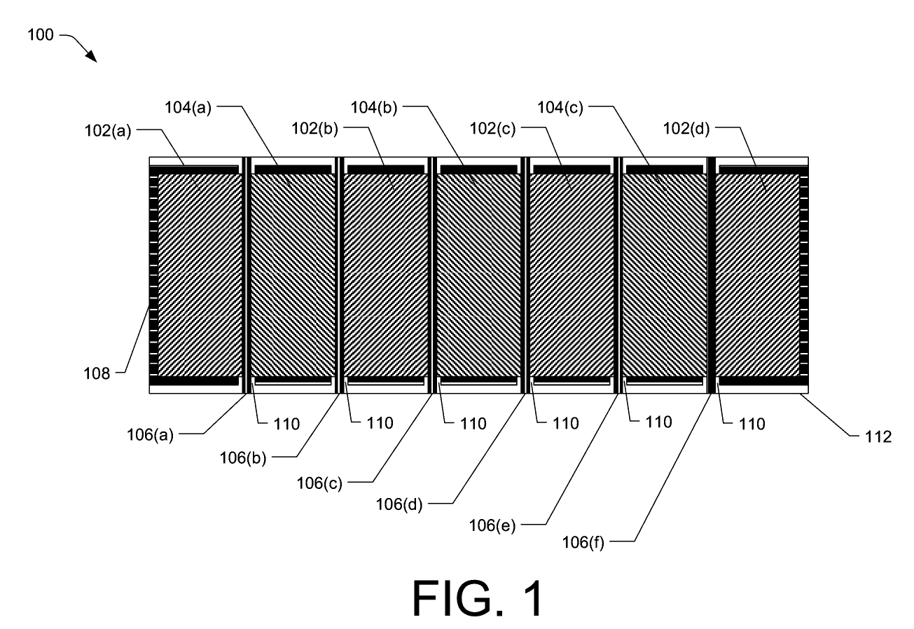

FIG. 1 illustrates an example of a battery system (100). System 100 may include one or more anodes 102 and one or more cathodes 104. Four anodes 102(a)-102(d) are shown in FIG. 1 by way of example. Three cathodes 104(a)-104(c) are shown in FIG. 1 by way of example. More or less anodes 102 and/or cathodes 104 may be present. The anodes 102 and cathodes 104 may be in a liquid state or a partially liquid state. The anodes 102 may have a first thickness and the cathodes 104 may have a second thickness. System 100 may also include one or more electrolytes 106. Six electrolytes 106(a)-106(f) are shown in FIG. 1 by way of example. More or less electrolytes 106 may be present. The anodes 102 may include a conductive material, such as, for example, sodium metal. The cathodes 104 may include a second material so as to provide a favorable standard cell potential and reversible chemical reaction.

System 100 may contain N cathodes and N+1 anodes (where N is any integer), the width and volume of which may be uniform or non-uniform to enable variable power density. System 100 may be assembled in a planar geometry or, for example, in a concentric cylinder geometry that provides N+1 independent battery cells with a combined voltage of (N+1)*E(cell).

The electrolytes 106 may be substantially solid and may have a density of at least 95%. In examples, the density of the electrolytes 106 may be at least 85%, at least 90%, at least 95%, at least 96%, at least 97%, at least 98%, or at least 99% of theoretical mass density. In examples, the density of the electrolytes 106 may be between approximately 85% and approximately 99%, between approximately 90% and approximately 99%, between approximately 90% and approximately 97.5%, between approximately 93% and approximately 97%, or between approximately 94% and approximately 96%. The electrolytes 106 may also have a third thickness, which may be less than the first thickness of the anodes 102 and/or the second thickness of the cathodes 104. In examples, the third thickness of the electrolytes 106 may be less than approximately 1 millimeter, less than approximately 500 micrometers, less than approximately 400 micrometers, less than approximately 300 micrometers, less than approximately 200 micrometers, less than approximately 100 micrometers, less than approximately 50 micrometers, less than approximately 25 micrometers, less than approximately 20 micrometers, or less than approximately 10 micrometers. In examples, the electrolytes 106 may have a thickness of between approximately 1 millimeter and approximately 10 micrometers, between approximately 500 micrometers and approximately 10 micrometers, between approximately 200 micrometers and approximately 10 micrometers, between approximately 100 micrometers and approximately 10 micrometers, between approximately 25 micrometers and approximately 10 micrometers, or between approximately 20 micrometers and approximately 10 micrometers. In examples, the electrolytes 106 may be between approximately 10 micrometers and approximately 5 micrometers. In examples, the third thickness of the electrolytes 106 may be, for example, approximately 1/10 of the first thickness of the anodes 102 and/or the second thickness of the cathodes 104, or approximately 1/15, or approximately 1/20, or approximately 1/25 of the first thickness and/or the second thickness. The electrolytes 106 may include a material with suitable ionic conductivity of the oxidized anode chemical species while retaining impermeability to the cathode species and anode/cathode reaction products.

System 100 may also include a housing 108. The housing 108 may be a first housing and may enclose all or a portion of the anodes 102, the cathodes 104, and the electrolytes 106. In examples, the housing 108 may enclose only a first portion of the electrolytes 106, while a second portion of the electrolytes 106 may extend through one or more grooves 110 in the housing 110. The grooves 110 may be disposed on opposing ends of the housing 110 and may be sized such that the electrolytes 106 extend through the grooves 110 to an exterior of the housing 108. Twelve grooves 110 are shown in FIG. 1, by way of example. More or less grooves 110 may be present. The housing 108 may include a low density polymeric material that tolerates high temperatures and is resistant to reactive chemicals produced in the chemical reaction. Such a material may be, for example, Zytel® FE5382 polyamide resin (Dupont) or polyamide resin PA612-GF33.

In examples, the anodes 102 and/or the cathodes 104 may have uniform or varying thicknesses. For example, anode 102(a) may be thicker or thinner than anode 102(b). Additionally, electrolytes 106 may have uniform or varying thicknesses. For example, electrolyte 106(a) may be thicker or thinner than electrolyte 106(b). The anodes 102 may include any oxidizable metal, more specifically, sodium metal. The cathodes 104 may include a complementary redox couple material to the anode, such as, for example, sulfur. The electrolytes 106 may be made from at least one of alpha-alumina powder, sodium oxide powder, or lithium oxide powder. In examples, the sodium oxide powder may be approximately 8.85% by weight of the electrolytes 106. In examples, the lithium oxide powder may be approximately 0.75% by weight of the electrolytes 106. In examples, the sodium oxide powder may be between approximately 5% and approximately 10% by weight of the electrolytes 106, or between approximately 8% and approximately 10% by weight of the electrolytes 106, or between approximately 8% and approximately 9% by weight of the electrolytes 106. In examples, the lithium oxide powder may be between approximately 0.25% and approximately 1.5% by weight of the electrolytes 106, or between approximately 0.5% and approximately 1.0% by weight of the electrolytes 106, or between 0.7% and approximately 0.8% by weight of the electrolytes 106.

System 100 may also include a second housing 112, which may enclose all or a portion of housing 108. The second housing 112 may function as an exterior casing for system 100, which may protect system 100 from the exterior environment and may protect devices and people using and/or handling system 100 from the components of system 100. The second housing 112 may be constructed of high temperature, low density, chemically resistant thermoplastics.

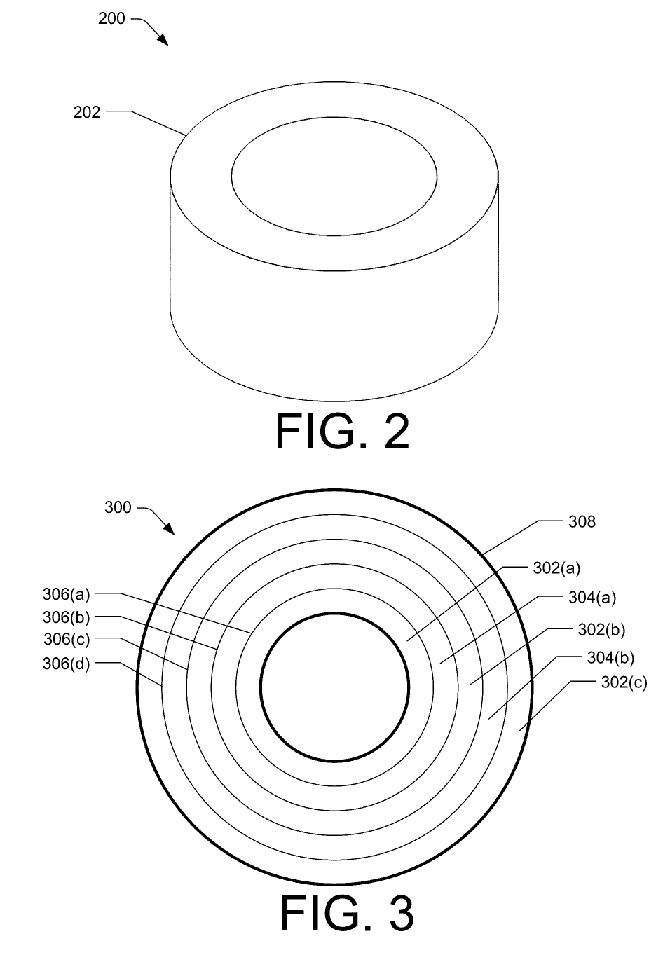

FIG. 2 illustrates an example of a battery system (200). System 200 may include all or some of the components of system 100. For example, system 200 may include (not shown), one or more anodes, one or more cathodes, one or more electrolytes, and a first housing that may include grooves. System 200 may also include a second housing 202, which may be similar to the second housing 112 from system 100. System 200 may be arranged in a non-planar geometry. For example, system 200 may be arranged in a cylindrical geometry. The height of the cylinder may vary. For example, the height may be between approximately 1 millimeter and approximately 25 centimeters, or between approximately 1 centimeter and approximately 20 centimeters, or between approximately 5 centimeters and approximately 15 centimeters, for example. The diameter of the cylinder may also vary. For example, the diameter may be between approximately 1 centimeter and approximately 1 meter, or between approximately 2 centimeters and approximately 500 centimeters, or between approximately 3 centimeters and approximately 100 centimeters, for example. The concentric cylindrical geometry may provide an alternating electrode battery configuration, with the concentric cylinder geometry providing support for the thin electrolyte to prevent or minimize cracking or failure. In examples, the annular volume of the electrodes and the electrode composition may vary to improve energy or power density of specific cells within the system.

FIG. 3 illustrates a top cross-sectional view of an example of a storage battery system (300). System 300 may include all or some of the components of system 100. For example, system 300 may include, one or more anodes 302(a)-302(c), one or more cathodes 304(a)-304(b), one or more electrolytes 306(a)-306(d), and a housing 308. System 300 may be arranged in a non-planar geometry. For example, system 300 may be arranged in a concentric cylindrical geometry. In examples, the anodes 302, cathodes 304, and electrolytes 306 may be disposed in one or more layers. When multiple layers are present, the layers may have uniform or varying thickness.

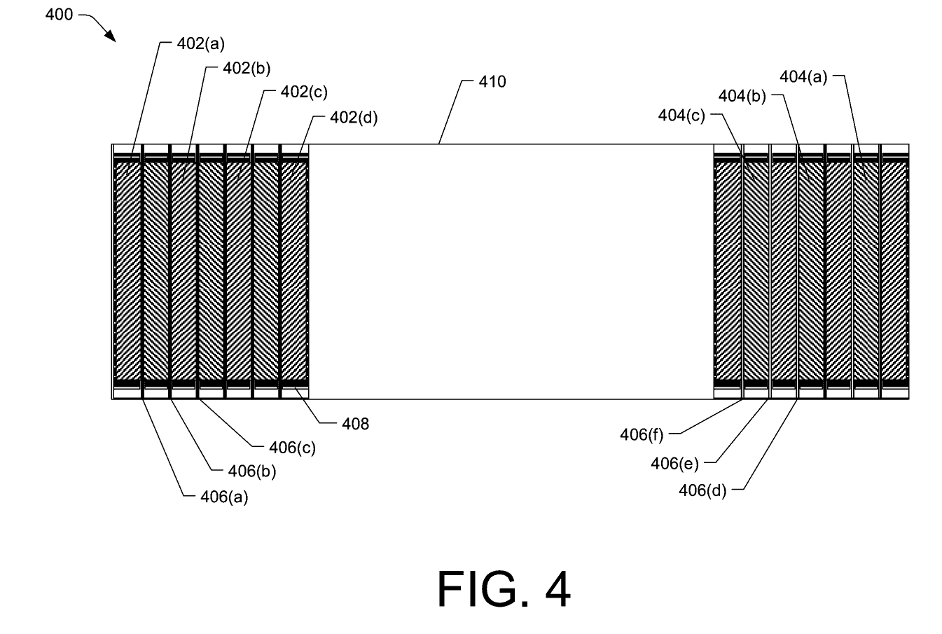

FIG. 4 illustrates a side cross-sectional view of an example of a battery system (400). System 400 may include all or some of the components of system 100. For example, system 400 may include, one or more anodes 402(a)-402(d), one or more cathodes 404(a)-404(c), one or more electrolytes 406(a)-406(f), a first housing 408, and a second housing 410. System 400 may be arranged in a non-planar geometry. For example, system 400 may be arranged in a concentric cylindrical geometry. All or some of the anodes 402, the cathodes 404, and the electrolytes 406 may be continuous such that the anodes, cathodes, and electrolytes are shaped as open cylinders. Additionally, system 400 may include one or more layers that may span from the center of the cylindrical geometry to the outer boundary of the cylindrical geometry. In examples, the layers of system 400 may terminate a point other than the center of the cylindrical geometry, leaving a space in the center of system 400, as shown in FIG. 4.

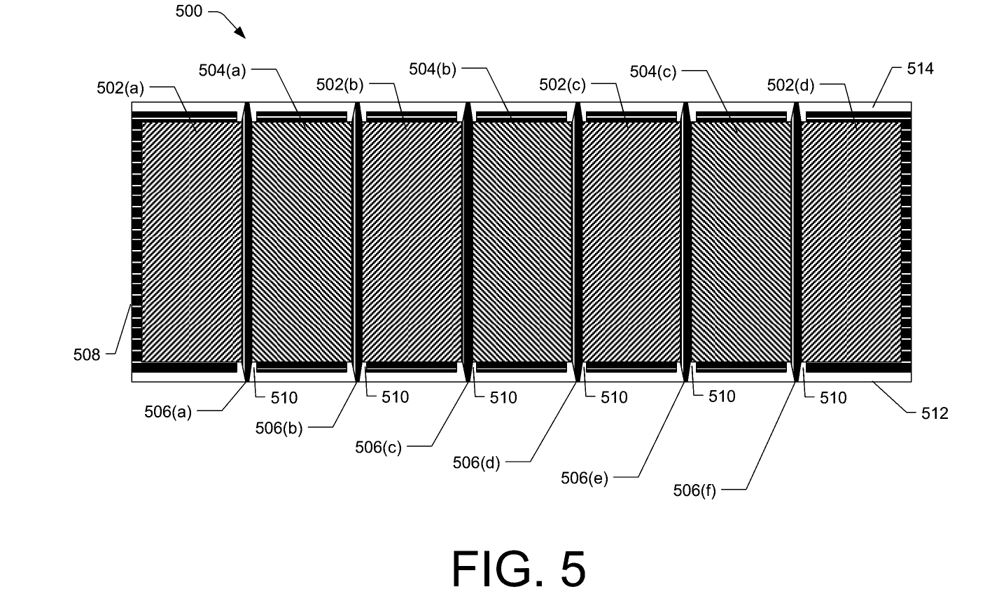

FIG. 5 illustrates a side cross-sectional view of an example of a battery system (500). System 500 may include all or some of the components of system 100. For example, system 500 may include one or more anodes 502(a)-502(d), one or more cathodes 504(a)-504(c), one or more electrolytes 506(a)-506(f), a first housing 508 having grooves 510, and a second housing 512. System 500 may also include a sealant 514. The sealant 514 may cover at least a portion of the first housing 508 and may function as a barrier or partial barrier between the anodes 102 and the cathodes 104. For example, as shown in FIG. 5, the electrolytes 506 function to separate the anodes 102 and the cathodes 104. However, a space may be present at or near the grooves 510, which may allow a portion of the anodes 502 and/or the cathodes 504, which may be liquid, to be displaced. As such, the sealant 514 may be applied such that the grooves 510 are sealed, preventing or hindering displacement of the anodes 502 and/or the cathodes 504. The sealant 514 may include, for example, a heat resistant, chemically resistant polymer. For example, sealant 514 may include Zytel® FE5382 polyamide resin (Dupont) or polyamide resin PA612-GF33. The anodes 502, cathodes 504, and electrolytes 506 may be sealed along a large surface area using the sealant 514, which may include a chemically resistant polymer compatible with the electrode and electrolyte materials.

The grooves 510 of system 500 may be chamfered, beveled, or rounded. The chamfered, beveled, or rounded grooves 510 may promote receiving the electrolytes 106 into and through the first housing 508.

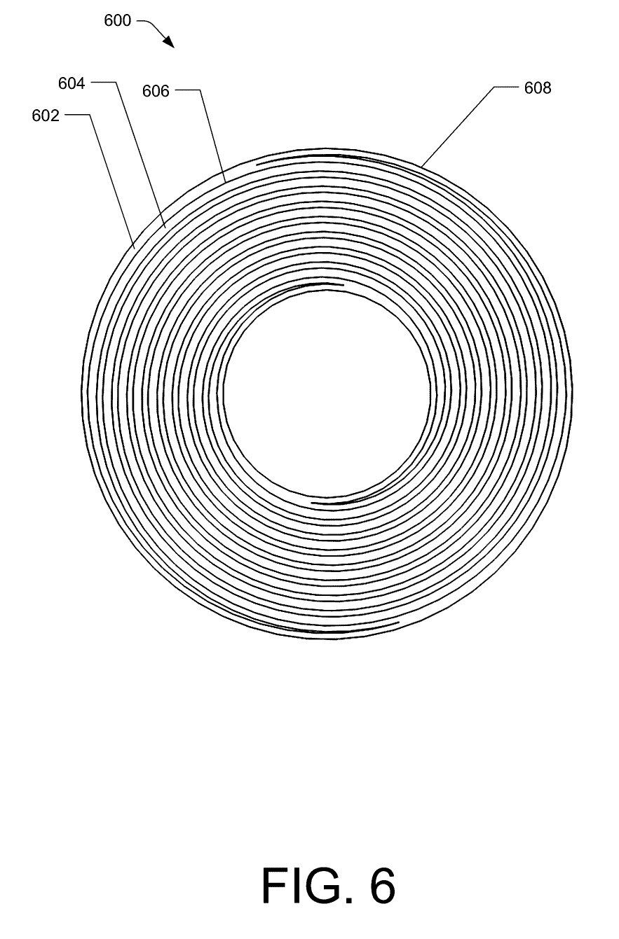

FIG. 6 illustrates a top cross-sectional view of an example of a battery system (600). System 600 may include all or some of the components of system 100. For example, system 600 may include one or more anodes 602, one or more cathodes 604, one or more electrolytes 606, and a housing 608. System 600 may be arranged in a non-planar geometry. For example, system 600 may be arranged in a helical geometry. The helical geometry may have alternating anodes 602 and cathodes 604 separated by the thin, solid electrolyte 606. In this geometry, the annular volume may be constant across cells, or may vary. Additionally, the annular width of the cells may be constant or vary. The helical electrolyte 606 may be scaled to accommodate a desired number of independent cells, the cells being arranged in series or parallel in either charge or discharge operation modes. The concentric array may be tailored to specific energy or power requirements by optimizing the cell dimensions described herein. The benefit of employing a thin film cylindrical electrolyte 606 includes the annular cylinders providing a self-supporting framework to strengthen the electrolyte 606 against lateral forces cause by pressure differentials during battery discharge.

In use, delivery of electricity from a battery, such as the battery systems described herein, arises from an oxidation/reduction reaction between an anode and cathode across a conductive electrolyte. The standard cell potential or voltage generated by the battery is determined by the specific oxidation/reduction reaction occurring between the two electrodes. The amount of stored energy in a battery is dependent on the relative dimensions of the electrodes and the specific reaction chemistry. The rate at which energy is delivered or power is determined depends on, for example 1) the relative interaction between the two electrodes across the electrolyte, 2) the rate of the chemical reaction, and 3) the internal resistance of the battery. The battery may discharge by an anode/cathode reaction that leads to reaction products. The reverse reaction occurs during battery charging. The amount of energy stored, the rate at which the energy can be delivered, the temperature at which the battery operates, and the reversibility of the electrochemical reaction are some of the important characteristics of a battery. In some applications, such as, for example, wind power storage and distribution the configurability of the presently disclosed battery systems provides marked improvement over previously-known battery systems. Additional specific applications include aviation and other mobile applications. Furthermore, voltage of the battery systems described herein may be determined based on the number of cells of the system. For example, in the concentric cylindrical geometry, each cell (or layer) may have a voltage potential of 2.1 volts. By adding layers, the voltage potential increases to a desired amount.

The problems described above with previous battery configurations limit the energy and power the battery may deliver in addition to limiting the number of cycles that the battery can be charged/discharged. These problems are solved by the presently disclosed battery systems, which achieve a comparatively high energy density, moderate operating temperature battery that cycles reliability for an extended time period without failure and with minimal loss in energy/power output.

For example, the thin electrolyte, as described above, promotes lower operating temperature. Additionally, the density of the electrolyte, as described above, provides a durability that allows the battery system to withstand the forces present in battery operation. Furthermore, high energy density is achieved by utilizing high energy density anode and cathode materials, such as sodium metal and sulfur, and minimizing electrolyte and housing mass. Charge/discharge cycling is improved through selection of reversible oxidation/reduction reaction chemistry with minimal thermodynamically or kinetically allowed side reactions. For example, a sodium/sulfur anode/cathode system may be used. Battery mass may be minimized by utilizing low density functional materials. In examples, an optimal temperature for battery operation is application dependent, although generally the temperature may be less than 50° C., or for example between approximately 50° C. to approximately 100° C. The operating temperature for molten salt sodium-sulfur may be, for example, 300° C., although changing electrolyte and/or electrode composition may result in lower operating temperatures, albeit at the cost of one or more of the limitations described.

Additional drawbacks to battery designs before the present disclosure include employing metal containment vessels which sacrifice mass and result in lower practical energy density. Other battery designs attempt to change chemistry combinations to improve cycling, which adds non-energy contributing mass in the form of anode wetting agents (cesium) or high surface area cathode structures (microporous/nanoporous carbon, for example), sacrificing energy density for cyclability. Furthermore, previous designs attempt to minimize electrolyte thickness in planar geometries, which decreases the mechanical strength of the membranes and leads to battery failure. Thin planar membranes are inherently weak and subject to cracking in addition to being difficult to seal. Traditional beta alumina electrolyte fabrication methods for thin planar membranes are time consuming and limited to simple planar geometries.

Electrical circuitry may also be included to promote electric current extraction from the cathode and current injection to the anode during discharge with collectors. The cathode may contain a high surface area conductive framework to provide an electrical current path and scaffold on which the chemical reaction may occur. The relative geometry of the anode, cathode, and electrolyte may determine the power density for a given cell chemistry. As such, the system geometry may include a high surface area electrolyte interface between electrodes to promote faster transport of anode ions to the cathode and increase the electric current per unit time.

The components described above in the present disclosure and as shown in FIGS. 1-6 may be separate components coupled together, or may be produced as one component or as combined components. When the various components described in the present disclosure are separate components, some or all of the components may be releasably coupled to the other components.

The components of the systems described herein may be of varying sizes and scales. For example, in applications where a relatively small amount of energy is needed, the systems may be relatively small, such as, for example, the size of a household battery. In other applications where a large amount of energy is needed, the system may be relatively larger, such as, for example, in automotive and aerospace applications. Additionally, multiple battery systems as described herein may be coupled to each other.

The various components of the systems disclosed herein may have additional grooves, slots, indentations, and other components to facilitate the function of the components as described herein.

The various components of the systems disclosed herein may be made using techniques known to those having skill in the art or as described more fully below.

The systems described herein, in practice, show increased energy density from 170 Wh/kg to 240 Wh/kg, decreased battery mass by 15 to 35%, increased charging efficiency by 5-10%, and decreased operating temperature by 15-25%. This results in a longer lasting, safer, more customizable battery system.

While a number of measurements described herein are given using the metric system, other or additional units of measurement that are substantial equivalents are also disclosed.

### Exemplary Method of Manufacture

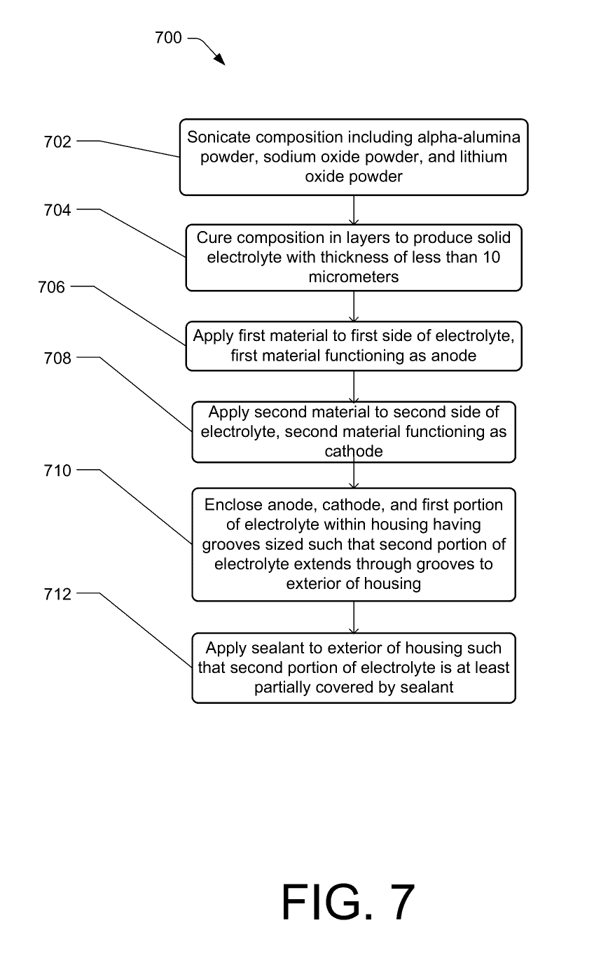

FIG. 7 illustrates an example method for manufacturing storage batteries. Method 700 is illustrated as a logical flow graph. The order in which the operations or steps are described is not intended to be construed as a limitation, and any number of the described operations may be combined in any order and/or in parallel to implement method 700.

Turning now to FIG. 7, there is illustrated an exemplary method 700 of manufacturing battery systems.

At block 702, method 700 may include sonicating a composition that may include at least one of alpha-alumina powder, sodium oxide powder, or lithium oxide powder. In examples, the alpha-alumina powder may have a particle diameter of less than 1 micrometer. In examples, the sodium oxide powder may be approximately 8.85% by weight of the composition. In examples, the lithium oxide powder may be approximately 0.75% by weight of the composition. In examples, the sodium oxide powder may be between approximately 5% and approximately 10% by weight of the electrolytes 106, or between approximately 8% and approximately 10% by weight of the electrolytes 106, or between approximately 8% and approximately 9% by weight of the electrolytes 106. In examples, the lithium oxide powder may be between approximately 0.25% and approximately 1.5% by weight of the electrolytes 106, or between approximately 0.5% and approximately 1.0% by weight of the electrolytes 106, or between 0.7% and approximately 0.8% by weight of the electrolytes 106. The sonicating may be performed using ultrasonic vibrations. The length of time for sonication may vary, and may be, for example for approximately the length of time that curing occurs, which is described below, or for example for a period of time before curing to promote densification of the electrolyte material. The ultrasonic frequency may be between approximately 0.5 kHz and approximately 10 kHz, or between approximately 1 kHz and approximately 7.5 kHz, or between approximately 2 kHz and approximately 5 kHz.

The sonication described herein may increase electrolyte density. An ultrasonic transducer may be coupled to the build stage in introduce the ultrasonic waves. Ultrasonic waves may be introduced continuously during the fabrication process and may propagate through the stage and into the powder. The interaction between ultrasonic energy and powder particles results in high density particle arrangement prior to or during curing. This ultrasonically densified electrolyte may result in increased density in the completed structure. The electrolyte manufactured using the techniques described herein may lower the operating temperature of the battery by reducing the internal battery resistance.

At block 704, method 700 may include curing the composition in layers to produce a solid electrolyte. The electrolyte may have a thickness of, for example, less than approximately 1 millimeter, less than approximately 500 micrometers, less than approximately 400 micrometers, less than approximately 300 micrometers, less than approximately 200 micrometers, less than approximately 100 micrometers, less than approximately 50 micrometers, less than approximately 25 micrometers, less than approximately 20 micrometers, or less than approximately 10 micrometers. In examples, the electrolytes 106 may have a thickness of between approximately 1 millimeter and approximately 10 micrometers, between approximately 500 micrometers and approximately 10 micrometers, between approximately 200 micrometers and approximately 10 micrometers, between approximately 100 micrometers and approximately 10 micrometers, between approximately 25 micrometers and approximately 10 micrometers, or between approximately 20 micrometers and approximately 10 micrometers. In examples, the electrolytes 106 may be between approximately 10 micrometers and approximately 5 micrometers. In examples, the third thickness of the electrolytes 106 may be, for example, approximately 1/10 of the first thickness of the anodes 102 and/or the second thickness of the cathodes 104, or approximately 1/15, or approximately 1/20, or approximately 1/25 of the first thickness and/or the second thickness. In examples, the density of the electrolytes may be at least 85%, at least 90%, at least 95%, at least 96%, at least 97%, at least 98%, or at least 99%. In examples, the density of the electrolytes 106 may be between approximately 85% and approximately 99%, between approximately 90% and approximately 99%, between approximately 90% and approximately 97.5%, between approximately 93% and approximately 97%, or between approximately 94% and approximately 96%.

The method of manufacturing battery systems as described herein may include using selective laser sintering/selective laser melting. This method may produce alumina structures having high density and complex geometry. For example, in situ fabrication of β-alumina thin solid electrolyte (BASE) membranes is described herein. Fabrication may include using high purity alpha-alumina powder of less than 1 micrometer particle diameter, or less than 0.5 micrometer particle diameter, or less than 0.3 micrometer particle diameter mixed with, for example, sodium oxide powder and lithium oxide powder. The powder may be combined, homogenized, and introduced into a SLS/SLM machine. The electrolyte geometry can be a variety of shapes as desired by the battery cell design, such as a concentric cylindrical geometry or a helical geometry.

The curing may be performed by, for example, selective laser sintering or stereolithography. While curing, the surface where the curing is performed may be maintained above approximately 1,500° C. to alleviate thermal stress cracking during melt pool formation. In examples, the surface may be maintained at a temperature between approximately 1,500° C. and approximately 2,000° C., or between approximately 1,500° C. and approximately 1,750° C., or between approximately 1,500° C. and approximately 1,600° C. The surface may be maintained at the temperatures described herein through use of, for example, diffuse laser heating or localized tube furnace heated.

At block 706, method 700 may include applying a first material to a first side of the electrolyte. The first material may function as an anode. The anode may be in a liquid state or a partially liquid state. The anode may include a conductive material, such as, for example, sodium metal.

At block 708, method 700 may include applying a second material to a second side of the electrolyte. The second material may function as a cathode. The cathode may be in a liquid state or a partially liquid state. The cathode may include a material so as to provide a favorable standard cell potential and reversible chemical reaction. The system may contain N cathodes and N+1 anodes (where N is any integer), the width and volume of which may be uniform or non-uniform to enable variable power density. The system may be assembled in a planar geometry or, for example, in a concentric cylinder geometry that provides N+1 independent battery cells with a combined voltage of (N+1)*E(cell). In examples, the thickness of the electrolyte may be approximately 1/10 of the thickness of the anode and/or the thickness of the cathode.

At block 710, method 700 may include enclosing the anode, the cathode, and a first portion of the electrolyte within a housing having grooves sized such that a second portion of the electrolyte extends through the grooves to an exterior of the housing.

At block 712, method 700 may include applying a sealant to the exterior of the housing such that the second portion of the electrolyte is at least partially covered by the sealant. The sealant may cover at least a portion of the housing and may function as a barrier or partial barrier between the anode and the cathode. For example, the electrolyte functions to separate the anode and the cathode. However, a space may be present at or near the grooves, which may allow a portion of the anode and/or the cathode, which may be liquid, to be displaced. As such, the sealant may be applied such that the grooves are sealed, preventing or hindering displacement of the anode and/or the cathode. The sealant may include, for example, a heat resistant, chemically resistant polymer. For example, sealant 514 may include Zytel® FE5382 polyamide resin (Dupont) or polyamide resin PA612-GF33.

The anode, cathode, and electrolyte may be sealed along a large surface area using the sealant, which may include a chemically resistant polymer compatible with the electrode and electrolyte materials.

The housing described above may be constructed of low density, chemically resistant, heat resistant material. The housing may be made from high temperature polymer, such as, for example, Ultem 9085. The grooves in the housing, as described herein, may be substantially straight, chamfered, beveled, or rounded to improve ease of receiving the electrolyte. A lid may be provided with a recessed annular groove pattern corresponding to grooves of the housing. The lid may be sealed on the upper edge of the electrolyte using the sealant. There may also be connection feedthrough holes to provide a means for external circuit completion and energy extraction. Such connection holes may be adjacent to or the grooves. Multi-cell reactor arrangements as well as single cell reactor configurations are provided.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

### CONCLUSION

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A battery, comprising:
an anode, at least a portion of the anode being liquid, the anode having a first thickness;
a cathode, at least a portion of the cathode being liquid, the cathode having a second thickness;
an electrolyte, the electrolyte being solid and having a density of at least 95%, the electrolyte having a third thickness, the third thickness being at least one-tenth of at least one of the first thickness or the second thickness; and
a housing enclosing the anode, the cathode, and at least a portion of the electrolyte.

2. The system of claim 1, wherein the anode, the cathode, and the electrolyte are configured in a concentric cylindrical geometry.

3. The system of claim 1, wherein the third thickness is less than 0.5 millimeters.

4. The system of claim 1, wherein the third thickness is less than 10 micrometers.

5. The system of claim 1, wherein the electrolyte is constructed of alpha-alumina powder, sodium oxide powder, and lithium oxide powder.

6. The system of claim 1, further comprising:
a plurality of grooves disposed on opposing ends of the housing, the plurality of grooves sized such that a portion of the electrolyte extends through the plurality of grooves to an exterior of the housing.

7. The system of claim 6, further comprising:
a sealant covering at least a portion of the grooves such that the anode and cathode are separated from each other.

8. A battery, comprising:
an electrolyte, the electrolyte being solid and having a density of at least 95%, the electrolyte being configured in two or more layers with each of the two or more layers having a concentric cylindrical geometry;
wherein for at least one of the two or more layers:
a first material, representing an anode, is disposed on a first side of the electrolyte, the first material being in a liquid state; and
a second material, representing a cathode, is disposed on a second side of the electrolyte, the first side opposing the second side, the second material being in a liquid state.

9. The system of claim 8, further comprising:
a housing having a plurality of grooves configured such that a portion of the electrolyte extends through the grooves.

10. The system of claim 9, wherein the housing has a first side and a second side opposing the first side, the plurality of grooves disposed on the first side and the second side of the housing, the system further comprising:
a sealant covering at least a portion of the first side and the second side of the housing such that the sealant covers the portion of the electrolyte extending through the grooves.

11. The system of claim 10, wherein the sealant is Zytel® FE5382 polyamide resin (Dupont) or polyamide resin PA612-GF33.

12. The system of claim 9, wherein the grooves are chamfered, beveled, or rounded.

13. The system of claim 8, wherein the electrolyte is less than 10 micrometers thick.

14. A method of manufacturing a battery, comprising:
sonicating a composition including alpha-alumina powder, sodium oxide powder, and lithium oxide powder;
curing the composition in layers to produce a solid electrolyte, the electrolyte having a thickness of less than 10 micrometers;
applying a first material to a first side of the electrolyte, the first material functioning as an anode;
applying a second material to a second side of the electrolyte, the second material functioning as a cathode;
enclosing the anode, the cathode, and a first portion of the electrolyte within a housing having grooves sized such that a second portion of the electrolyte extends through the grooves to an exterior of the housing; and
applying a sealant to the exterior of the housing such that the second portion of the electrolyte is at least partially covered by the sealant.

15. The method of claim 14, wherein the alpha-alumina powder has a particle diameter of less than 1 micrometer.

16. The method of claim 14, wherein the sodium oxide powder is approximately 8.85% by weight of the composition, and the lithium oxide powder is approximately 0.75% by weight of the composition.

17. The method of claim 14, wherein a surface where the curing is performed is maintained at approximately 1,500° C.

18. The method of claim 14, wherein the curing is performed by selective laser sintering.

19. The method of claim 14, wherein the curing is performed by stereolithography.

20. The method of claim 14, wherein a ratio of electrolyte thickness to anode thickness is at least 1/10.
